(19) United States
(12) Patent Application Publication
(10) Pub. No.: US 2013/0047088 A1
(43) Pub. Date: Feb. 21, 2013

(54) REPORTING FOCUS DURATION TO THE ADVERTISER

(71) Applicant: Theodore Van Belle, Santa Clara, CA (US)

(72) Inventor: Theodore Van Belle, Santa Clara, CA (US)

(21) Appl. No.: 13/213,653

(22) Filed: Aug. 19, 2011

(51) Int. Cl. G06F 3/048

(52) U.S. Cl. 715/738

(57) ABSTRACT

Methods, including a computer program product for collecting metrics for determining content presentation quality are provided. An application executing on a mobile device requests and receives virtual content for presentation on the mobile device. The application logs focus duration information associated with presented content and transmits the focus duration information to a virtual content server in subsequent requests for virtual content. The virtual content server aggregates the content focus duration information received in the requests for virtual content, and provides quality metrics to virtual content providers based in part on the aggregated focus duration information.

### BACKGROUND

This disclosure relates to content presentation, and more particularly to methods and systems for collecting metrics for determining content presentation quality.

As the availability of mobile devices, such as mobile phones, tablet devices, portable computers, and the like, continues to grow, more and more consumers/users, (herein referred to as users) are utilizing such devices to electronically access content previously accessed through other devices which among other things have greater display size. This in turn increases the need for content publishers to take into consideration how users will be viewing/access their content.

From an advertising perspective, the same concerns exist for the display of ads as well as landing pages in display restricted environments, such as mobile devices. Not only are advertisers concerned with displaying creatives, e.g., electronic ads, to mobile users in a manner that will entice the user to click on the creative/ad, but also in providing landing pages which will promote conversions. A “landing page” as referred to herein, is the content linked to in an electronic ad. For example, electronic ads commonly contain links to other electronic content such as web pages, images, video files, audio files and the like, this linked content is referred to a the “landing page.”

Although a mobile-device user may be enticed by a creative and click on it, if the user faces a landing page which is not mobile friendly, for example, containing a bunch of content in small font, they usually don't want to dig into the page on the mobile device. In addition, some landing pages may not render properly on a mobile device. For example, some mobile devices do not support Flash and/or do not execute a Javascript properly. Accordingly, the design of the landing page can have a large influence on whether or not a click-through results in a conversion. As a result, there is a need for metrics to help advertisers and/or publishers measure the quality of their creatives and landing pages.

### SUMMARY

This specification describes technologies relating to content presentation in general, and specifically to methods and systems for determining landing page duration.

In general, one aspect of the subject matter described in this specification can be embodied in a computer-implemented comprising executing an application on a mobile device; presenting a virtual content item to a user, the virtual content item including an associated identifier; if the virtual content item is selected by the user, logging the virtual content item identifier and a time stamp and redirecting the mobile device's focus away from the application; upon return of the focus to the application, converting the previously logged timestamp into a duration; and transmitting the logged virtual content item identifier and associated content focus duration to a content serving system.

Another aspect of the subject matter described in this specification can be embodied in a computer-implemented comprising receiving content focus duration information related to previously served content items from one or more applications running on a mobile device; aggregating the received content focus duration information; and providing a quality metric to virtual content providers based on the aggregated duration information.

These and other embodiments can optionally include one or more of the following features. The virtual content item identifier and associated content focus duration can be transmitted to the content server as extra common gateway interface parameters in subsequent requests for virtual content items. The received content focus duration information categorized into a plurality of predefined categories and aggregated on a per category, content item, and/or content provider basis.

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is a block diagram of an exemplary content presentation system.

FIG. 2 is a block diagram illustrating an exemplary advertising management server.

FIG. 3 is a flow diagram of an exemplary method for providing duration information to a content serving system

FIG. 4 is a flow diagram of an exemplary method for providing quality metrics to virtual content providers based in part on the aggregated duration information.

### DETAILED DESCRIPTION

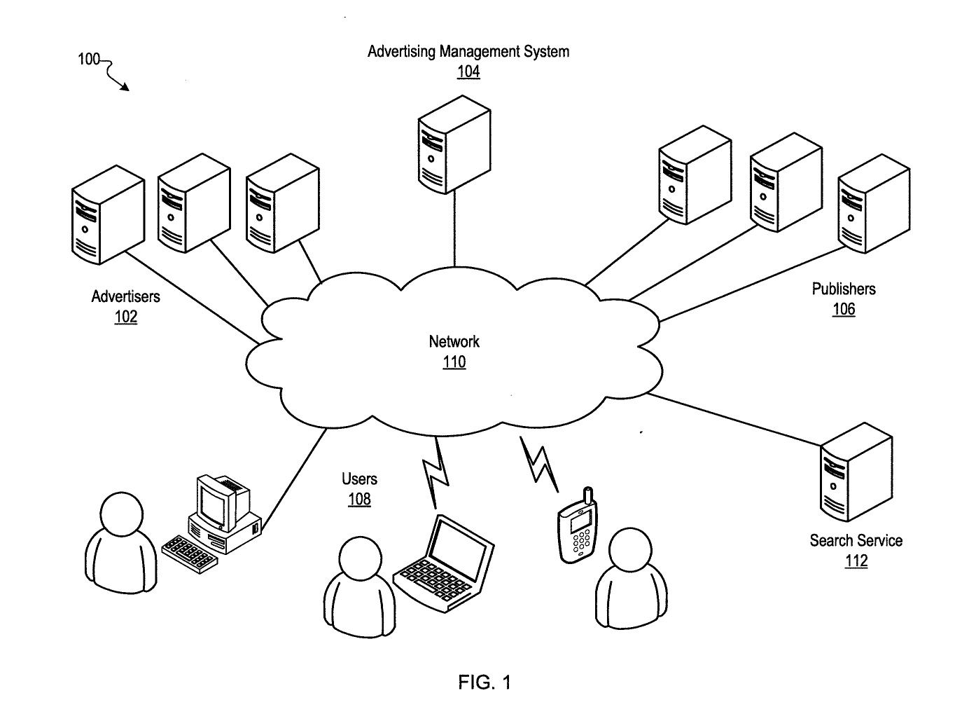

FIG. 1 is a block diagram of an exemplary content presentation system 100. The content presentation system can include many thousands of advertisers 102, publishers 106, user devices 108, and a search engine 110. Although reference is made to advertisements, other forms of content including other forms of sponsored content can be provided in the content presentation system 100.

Advertisers 102 can directly, or indirectly, enter, maintain, and log ad information in the advertising management system 104. Though reference is made to advertising, other forms of content, including other forms of sponsored content, can be delivered by the system 104. The ads can be in the form of graphical ads, such as banner ads, text only ads, image ads, barcode ads (i.e., ads including one or more barcodes, for example, for use in redeeming the ads), audio ads, video ads, ads combining one or more of any of such components, and so on. The ads can also include embedded information, such as links, meta-information, and/or machine executable instructions.

One or more publishers 106 can submit requests for ads to the system 104. The advertising management system 104 responds by sending ads to the requesting publisher 106 for placement on, or in association with, one or more of the publisher's properties. Exemplary publisher properties can include web pages, applications, streaming video/audio platforms and the like. Although advertisers 102 and publishers 106 are shown separately in FIG. 1, they can be the same entity, i.e., an advertiser can also be a publisher and vice versa.

Other entities, such as users 108 and advertisers 102, can provide usage information to the advertising management system 104, for example, whether or not a conversion (e.g., a purchase or other interaction) or a click-through related to an ad (e.g., a user has selected an ad) has occurred. This usage information can include measured or observed user behavior related to ads that have been provided for presentation.

A network 110 connects the advertisers 102, the advertising management system 104, the publishers 106, the users 108, and the search service 112. Network 110 can be a local area network (LAN), wide area network (WAN), the Internet, one or more telephony networks, a cloud computing network, or a combination thereof.

An exemplary publisher 106 is an application running on a user device, for example, a game running on a tablet or smart phone. The application can submit a request for an ad to advertising management system 104. The ad request can include various information for use by the advertising management system 104 in determining the ads to provide in response to the request. For example, the ad request can include the number of ads requested, information about the event which triggered the request, amount of ad space available for presenting/displaying the ad. In addition, the ad request can include various information about the device running the application.

Another exemplary publisher 106 is a general content server that receives requests for content (e.g., articles, discussion threads, music, video, graphics, search results, web page listings, information feeds, and so on), and retrieves the requested content in response to the request. The content server can submit a request for ads to an advertisement server in the advertising management system 104. The ad request can include the number of ads desired. The ad request can also include content request information. The content request information can include the content itself (e.g., page, video broadcast, radio show, or other type of content), a category corresponding to the content or the content request (e.g., arts, business, computers, arts-movies, arts-music, and so on), part or all of the content request, content age, content type (e.g., text, graphics, video, audio, mixed media, and so on), geo-location information, and so on.

Search service 112 can also submit a request for ads to the advertising management system 104. For example, ads can be requested for presentation along with the search results responsive to a received query. The request can include a number of ads desired. This number can depend on the search results, the amount of screen or page space occupied by the search results, the size and shape of the ads, and so on. The request for ads can also include the query (as entered or parsed), information based on the query (such as geo-location information, whether the query came from an affiliate and an identifier of such an affiliate), and/or information associated with, or based on, the search results.

In some implementations, the content server (or a client browser or the like) combines the requested content with one or more of the ads provided by the advertising management system 104. The combined content and ads can be served (e.g., sent) to the users 108 that requested the content for presentation in a viewer (e.g., an application on a mobile device). The content server can transmit information about the ads back to the advertisement server, including information describing how, when and/or where the ads are to be rendered (e.g., in hypertext markup language (HTML) or JavaScript™).

Search service 112 receives queries from a plurality of users 108. In response, the search service 112 retrieves relevant search results from an index of documents (e.g., from an index of web pages) and provides them to the requesting user. The search results identify resources responsive to the submitted query. Exemplary search results can include lists of web page titles, snippets of text extracted from those web pages, and hypertext links to those web pages, and can be grouped into a predetermined number (e.g., ten) of search results.

As noted above, the advertising management system 104 can collect usage information from advertisers 102, publishers 106, and/or users. This usage information can include measured or observed user behavior related to ads that have been served by the management system. A served ad is an ad that has been provided for presentation in response to a request for ad(s). In addition, the advertising management system 104 logs information related to the ads it serves.

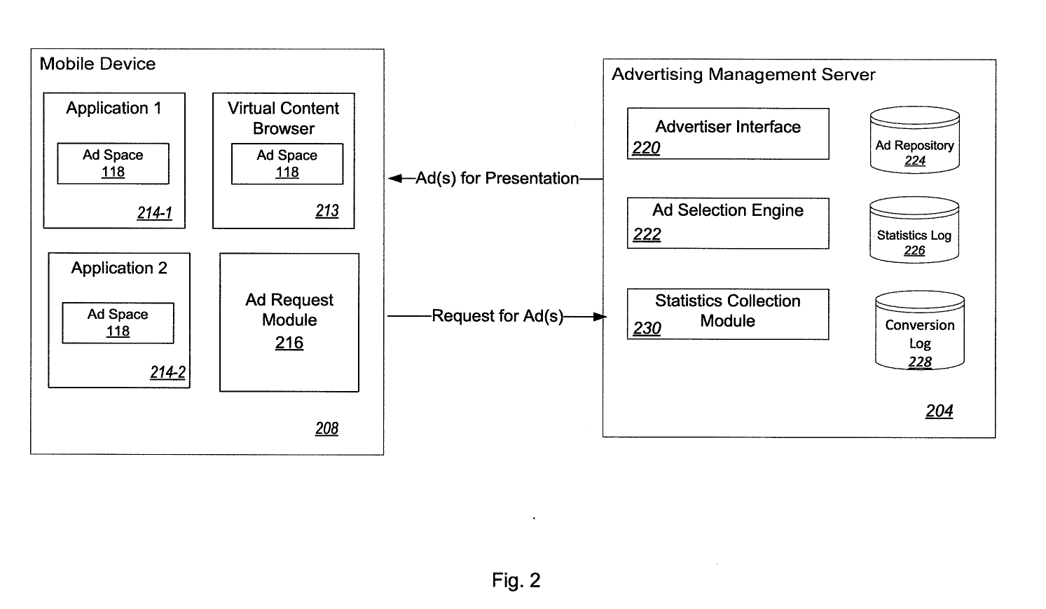

FIG. 2 is a block diagram of an exemplary advertising management server 204 operable to provide ads for presentation in response to a request for ad(s), for example from a mobile device 208. The mobile device 208 can include an ad request module 216. Although shown separately in FIG. 2, the ad request module 216 may be a part of virtual content browser 213 and/or a part of one or more application(s) 214-1, 214-2 stored on the device.

According an exemplary embodiment, the ad request module 216 is part of an application 214-1, 214-2 installed on the mobile device 208. The developer of the application has the ability to compile executable code into the application which upon one or more predefined events will submit a request for ads to the advertising management system 104. A broad range of triggerable events, conditions, user actions, and like may be predefined by the developer.

In addition to the information related to a particular ad request, various additional information regarding previously presented ads may be included in the ad request. For example, a request can include content focus duration information related to previously served ads (discussed in greater detail below). The additional information may be transmitted/provided to the advertising management system 104 via common gateway interface (CGI) parameters embedded in the ad request.

The ad server 204 includes an advertiser frontend interface 220 for creating advertisements and/or ad campaigns, ad repository 224 for storing ads, ad selection engine 222, statistics collection module 230, statistics log(s) 226, and conversion log(s) 228. The advertiser interface 220, ad selection engine 222, statistics collection module 230, ad repository 224, and statistics log 226 may be part of the advertising management server 204 as illustrated, or provided as independent components in communication with the advertising management server 204 in a manner known in the art. For example, advertising management server 204 may be provided as a distributed computing system.

Advertiser interface 220 provides an interface for advertisers 202 to create and manage ad campaigns. An ad campaign can be a simple of as a single creative with associated serving criteria or a plurality of creatives having related serving criteria. The serving criteria can include one or more parameters, provided by an advertiser or the advertising management system, indicating when, where and/or under what conditions particular creatives may be served. Using the advertiser interface 220, an advertiser can create a campaign by providing the content needed to present the different creatives and defining the serving criteria for the campaign. For example, the serving criteria parameters can include one or more of the following: one or more keywords or topics, geographic information, a value indication for the creative, start date, end date, and the like.

The advertiser interface 220 can include one or more tools to help an advertiser design a campaign and/or individual ad, also referred to as a creative. According to an exemplary embodiment, the advertiser interface 220 includes a content focus metrics tool which can be utilized by an advertiser or content providers to gauge ad and/or campaign quality.

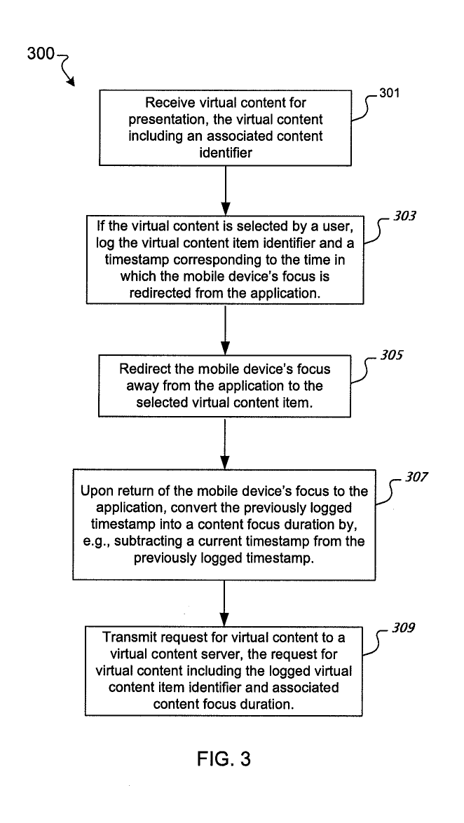

FIG. 3 illustrates an exemplary process for obtaining content focus duration information with respect to previously served content. The content focus duration information is received from applications running on user devices 108. In other words, the applications track the amount of time spend focusing on served content. For example, the amount of time spend on a “click-to-call”, “get driving directions”, and/or on a landing page.

An application 214-1, 214-2 can provide duration information associated with previously served ads by monitoring/logging focus changes in the mobile device. Generally, a focus change occurs when the active application or graphical user interface element (e.g., window or icon) changes. For example, when a user clicks from one window to another. Referring back to FIG. 3, the process begins with an application presenting received ads (i.e., content) on the mobile device running the application (step 301). The presented ads can take various forms and can include various selectable content such as click-to-talk, driving directions, video clips, URLs, and the like.

When a user selects a presented ad and/or linked content, the application logs an ad or content identifier associated with the selected content along with a timestamp corresponding to receipt of the request to change focus from the application (step 303). Focus is then redirected from the application to the requested content, for example, a video clip, an audio file, click-to-call, driving directions, landing page and the like (step 305). Upon return of the focus to the application, the previously logged timestamp is converted to a duration (step 307). This can be achieved, for example, by the application associating the ad identifier with the frame in which the content is displaying, so that when the user clicks on the content, the application stores a tuple containing the content identifier and the timestamp of the click. When focus is returned to the application, the application would then convert that tuple into a tuple containing the id and the duration of the click by subtracting the stored timestamp from a current time.

Finally, content focus duration information is transmitted to the ad server along with the ad/content identifier (step 309). The focus duration and ad/content identifier can be transmitted with a subsequent request for ads. In some instances, this duration information, e.g., the ad identifier and the focus duration value, are included in a request for ads transmitted to the ad server as extra common gateway interface (CGI) parameters in a subsequent ad request. For example, if the user spent 2 seconds on an ad with the id 123456, the next ad request might contain the parameters duration_id=123456&duration_time=2000.

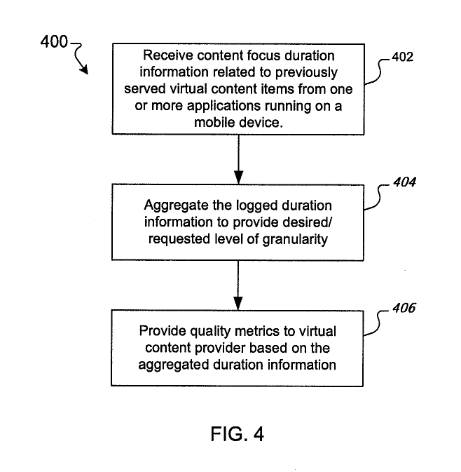

As illustrated in the FIG. 4, the ad server 204 provides quality metrics to content providers based on content focus duration information received from mobile applications 214-1, 214-1. The ad server 204 receives ad focus duration information related to previously served ads from one or more applications running on a mobile device (step 402). The ad focus duration information includes, an ad or content identifier for a previously served ad and an associated ad/content focus duration. The ad identifier and focus duration can be received, for example, as common gateway interface parameters embedded in a request for ads from an application running on a user device 108. The received ad/content focus duration information is logged for further analysis and processing.

Because an advertiser may create numerous ads and/or campaigns and each ad may be served numerous times on numerous user devices, the logged focus duration information is aggregated to provide various levels of granularity (step 404). For example, at a top level, the focus duration information may be aggregated on an advertiser basis, resulting in an average focus duration for all ads associated with a particular advertiser. In other instances, the focus duration information is aggregated on a campaign basis, resulting in focus duration information for each campaign created by an advertiser. In still other instances, the focus duration information is aggregated on an ad content basis, resulting in focus duration information for the various selectable options content in the ads. For example, click-to-call, driving directions, and/or video clips. The level of aggregation granularity can be predefined by the ad server 204 and/or selected by the advertiser, for example, as a user interface option of the quality metrics tool.

Finally, the quality metrics are provided to virtual content provider/advertiser based in part on the aggregated duration information (step 408). The quality metric could be as simple as the aggregated duration value or could be a parameter of more detailed metrics provided to the content provider/advertiser. For example, the logged duration information could be used to determine the miss click rate for a given ad. A miss click refers to a situation where a user mistakenly clicks on an ad. If a user selects an ad and them quickly redirects the focus back to the application (i.e., the duration is less than a predetermined value) this provides a good indication that the user did not intend to select/click on the ad. This type of detailed metric can be presented to the content provider/advertiser in the form of predefined categories, such as duration time ranges, or requesting application. This allows the advertiser to determine trends for future ad targeting. For example, the aggregated focus duration information may show that when a particular ad campaign is served to gaming applications there is a high number of miss clicks, whereas when served to non-gaming applications there are very few miss clicks.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Although this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, although operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The invention being thus described, it will be obvious that the same may be varied in many ways. Such variations are not to be regarded as a departure from the spirit and scope of the invention, and all such modifications, as would be obvious to one skilled in the art, are intended to be included with the scope of the following claims.

1. A computer-implemented method, comprising:
executing an application on a mobile device;
presenting, in response to a first request for virtual content items sent to a content serving system, a virtual content item to a user, the virtual content item including an associated identifier;
if the virtual content item is selected by the user, logging the virtual content item identifier and a time stamp and redirecting the mobile device's focus away from the application;
upon return of the focus to the application, converting the previously logged timestamp into a duration; and
transmitting, to the content serving system, the logged virtual content item identifier and associated content focus duration as common gateway interface parameters in a subsequent request for virtual content items.

2-3. (canceled)

4. A computer implemented method, comprising:
receiving, as common gateway interface parameters in requests for virtual content items, content focus duration information related to previously served content items from one or more applications running on a mobile device;
aggregating the received content focus duration information; and
providing a quality metric to virtual content providers based on the aggregated duration information.

5. The computer-implemented method of claim 4, wherein the content focus duration information includes a virtual content item identifier and associated content focus duration.

6. (canceled)

7. The method of claim 4, wherein aggregating the received content focus duration information comprises:
associating the received content focus duration information with a virtual content provider; and
determining an average content focus duration for each content provider.

8. (canceled)

9. The method of claim 4, wherein aggregating the received content focus duration information comprises:
associating the received content focus duration information with a virtual content provider;
for each virtual content provider,
categorizing the received content focus duration information into one of a plurality of predefined categories; and
aggregating the content focus duration information for each category.

10. The computer-implemented method of claim 9, wherein each of the predefined categories represents a particular time range.

11. (canceled)

12. The method of claim 4, wherein providing quality metrics to a virtual content provider comprises:
providing a graphical representation of an average duration with respect to each content identifier associated with the virtual content provider.

13. The method of claim 9, wherein providing quality metrics to a virtual content provider comprises:
providing a graphical representation of the number of durations received for each of the predefined categories.

14. A non-transitory computer readable storage medium, having stored thereon computer executable code that when executed causes one or more processors to perform the steps of:
receiving, as common gateway interface parameters in requests for virtual content items, content focus duration information related to previously served content items from one or more applications running on a mobile device;
aggregating the received content focus duration information; and
providing a quality metric to virtual content providers based on the aggregated duration information.

15. The computer readable storage medium of claim 14, wherein the content focus duration information includes a virtual content item identifier and associated content focus duration.

16. (canceled)

17. The computer readable storage medium of claim 14, wherein aggregating the received content focus duration information comprises:
associating the received content focus duration information with a virtual content provider; and
determining an average content focus duration for each content provider.

18. (canceled)

19. The computer readable storage medium of claim 14, wherein aggregating the received content focus duration information comprises:
associating the received content focus duration information with a virtual content provider;
for each virtual content provider,
categorizing the received content focus duration information into one of a plurality of predefined categories; and
aggregating the content focus duration information for each category.

20. The computer readable storage medium of claim 19, wherein each of the predefined categories represents a particular time range.

21. (canceled)

22. The computer readable storage medium of claim 14, wherein providing quality metrics to a virtual content provider comprises:
providing a graphical representation of an average duration with respect to each content identifier associated with the virtual content provider.

23. The computer readable storage medium of claim 19, wherein providing quality metrics to a virtual content provider comprises:
providing a graphical representation of the number of durations received for each of the predefined categories.

24. A non-transitory computer readable storage medium, having stored thereon computer executable code that when executed causes one or more processors to perform the steps of:
executing an application on a mobile device;
presenting, in response to a first request for virtual content items sent to a content serving system, a virtual content item to a user, the virtual content item including an associated identifier;
if the virtual content item is selected by the user, logging the virtual content item identifier and a time stamp and redirecting the mobile device's focus away from the application;
upon return of the focus to the application, converting the previously logged timestamp into a duration; and
transmitting, to the content serving system, the logged virtual content item identifier and associated content focus duration as common gateway interface parameters in a subsequent request for virtual content items.

25-26. (canceled)

27. The method of clam 1, wherein the virtual content item is an advertisement in the form of a click-to-talk link, a video clip, or a get driving directions link.

28. The computer readable medium of clam 24, wherein the virtual content item is an advertisement in the form of a click-to-talk link, a video clip, or a get driving directions link.

29. The method of clam 4, wherein the content item is an advertisement in the form of a click-to-talk link, a video clip, or a get driving directions link.

30. The computer readable medium of clam 14, wherein the content item is an advertisement in the form of a click-to-talk link, a video clip, or a get driving directions link.
